(19) United States
(12) Patent Application Publication
(10) Pub. No.: US 2009/0280677 A1
(43) Pub. Date: Nov. 12, 2009

(54) ILLUMINATED CIRCULAR PLASTIC CONNECTOR

(75) Inventor: Charles Raymond GINGRICH, III, Mechanicsburg, PA (US)

Correspondence Address: TYCO TECHNOLOGY RESOURCES, 4550 NEW LINDEN HILL ROAD, SUITE 140, WILMINGTON, DE, 19808-2952, US

(73) Assignee: TYCO ELECTRONICS CORPORATION, Berwyn, PA (US)

(21) Appl. No.: 12/116,356

(22) Filed: May 7, 2008

(51) Int. Cl. H01R 3/00

(52) U.S. Cl. 439/490; 439/488

(57) ABSTRACT

An illuminated circular plastic connector is disclosed that includes a connector socket and a connector plug. The connector socket is configured to receive light from a light source and illuminate the connector socket and/or the connector plug when the connector socket and connector plug are mated. The connector socket may include a dust cover having a light pipe attachment feature that receives light from the light source.

### FIELD OF THE INVENTION

The present invention relates generally to electrical connectors. More specifically, the present invention relates to illuminated circular plastic connector assemblies.

### BACKGROUND OF THE INVENTION

Electrical connectors are utilized to interconnect signals and power pathways to and from components. Generally, electrical connectors must be able to withstand connecting, disconnecting, and reconnecting of a socket and a plug.

In the medical industry, circular plastic connectors are used for connecting medical equipment to control boxes. The control box may be positioned in a manner difficult to reach, difficult to see, or in an area without adequate space. The control box may be located in an area with low ambient lighting.

One control box may have several plastic connectors attached to it. When control boxes have several plastic connectors attached, connectors are often color coded to differentiate between connectors. The color-coding can be difficult to see in low ambient lighting or when the control box is positioned in a place that is difficult to see.

Therefore, there is a need to provide a connector that is illuminated and allows differentiation between connectors in areas with low ambient lighting.

### SUMMARY OF THE INVENTION

In one embodiment of the present invention, an electrical connector assembly is disclosed that includes a connector plug including electrical contacts and a connector socket including corresponding electrical contacts and a light pipe attachment feature. The connector socket is configured to couple with the connector plug and form an electrical connection between the electrical contacts and the corresponding electrical contacts. The light pipe attachment feature is configured to receive light from a light source to illuminate the connector socket.

In another embodiment of the present invention, a method of illuminating an electrical connector assembly is disclosed that includes providing a light source and connecting a connector socket to the light source. The method further includes providing a connector plug. The connector plug is configured to couple with the connector socket. The connector plug is illuminated when the connector socket and connector plug are coupled.

In yet another embodiment of the present invention, a method of assembling a socket is disclosed. The method comprises providing a circular plastic connector socket; and attaching a part configured to permit light to travel through the circular plastic connector socket.

### BRIEF DESCRIPTION OF THE DRAWINGS

FIG. 1 illustrates a perspective view of an exemplary embodiment of a mated electrical connector assembly according to the invention.

FIG. 2 illustrates a perspective view of the electrical connector assembly of FIG. 1 unmated.

FIG. 3 illustrates a perspective view of another exemplary embodiment of a mated electrical connector assembly according to the invention.

FIG. 4 illustrates a perspective view of yet another exemplary embodiment of a mated electrical connector assembly according to the invention.

FIG. 5A illustrates an exploded perspective view of FIG. 1.

FIG. 5B illustrates an exploded perspective view of FIG. 1 taken from the reverse angle of FIG. 5A.

FIG. 5C illustrates an exploded view of an alternative embodiment of the connector assembly of FIG. 1.

FIG. 6 illustrates a perspective rear view of an exemplary dust cover.

FIG. 7 illustrates a perspective front view of the connector socket of FIG. 2.

FIG. 8 illustrates a perspective front view of the connector plug of FIG. 2.

FIG. 9 illustrates a cross-sectional view of the unmated electrical connector assembly of FIG. 2 taken along line 8-8.

FIG. 10 illustrates a cross-sectional view of a mated electrical connector assembly of FIG. 1 taken along line 9-9.

FIG. 11 illustrates a cross-sectional view of the unmated electrical connector assembly of FIG. 5C taken along line 11, which has the light pipe attached.

FIG. 12 illustrates a cross-sectional view of the unmated electrical connector assembly of FIG. 5C taken along line 11, which has been mated and has the light pipe attached.

Wherever possible, the same reference numbers will be used throughout the drawings to refer to the same or like parts.

### DETAILED DESCRIPTION OF THE INVENTION

The present invention now will be described more fully hereinafter with reference to the accompanying drawings, in which a preferred embodiment of the invention is shown. This invention may, however, be embodied in many different forms and should not be construed as limited to the embodiments set forth herein; rather, these embodiments are provided so that this disclosure will be thorough and complete and will fully convey the scope of the invention to those skilled in the art.

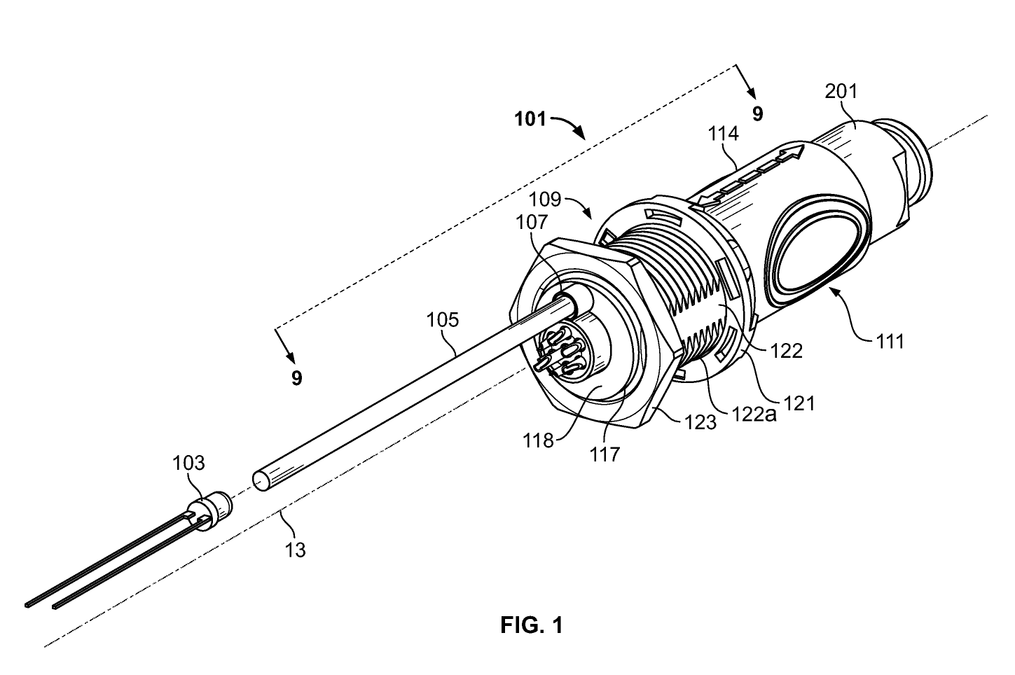

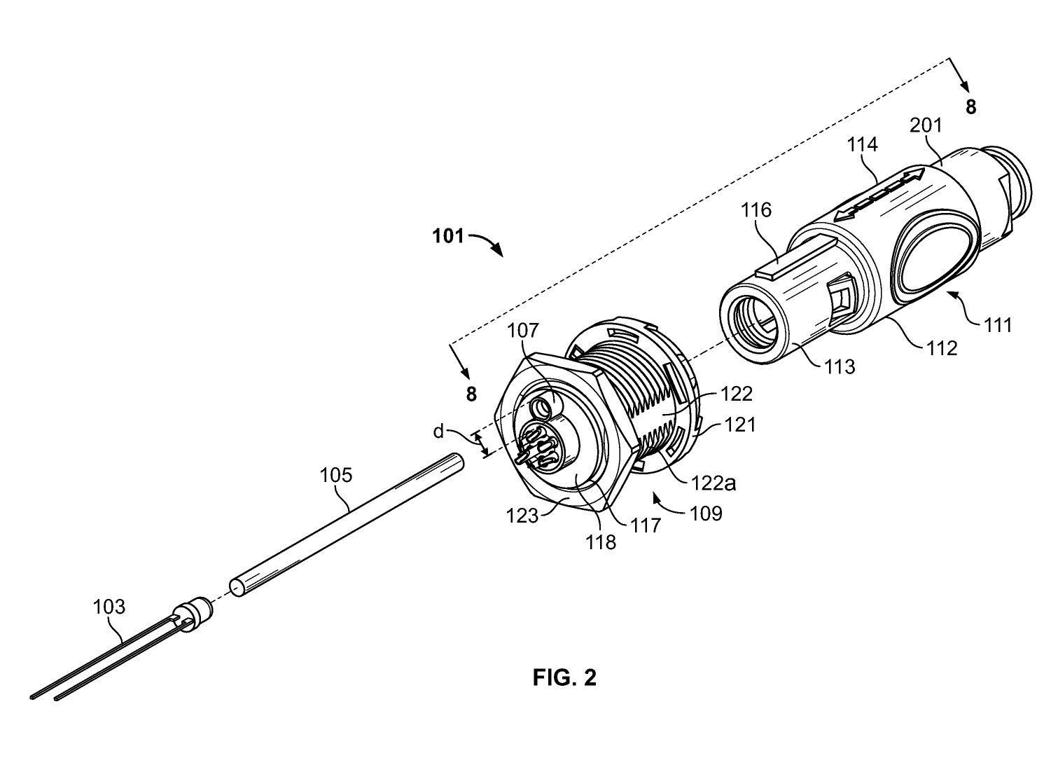

An exemplary embodiment of an electrical connector assembly 101 according to the present invention is shown in FIGS. 1 and 2. The electrical connector assembly 101 includes a connector socket 109 and a connector plug 111. The connector socket 109 and connector plug 111 are shown mated in FIG. 1, and unmated in FIG. 2. The connector socket 109 and connector plug 111 are configured to be releasably mated, as will be described in further detail below. The connector socket 109 and connector plug 111 are further configured to house corresponding electrical contacts (not shown) that mate when the connector socket 109 and connector plug 111 are mated. A light pipe 105 provides light from a light source 103 to illuminate the connector socket 109 and the connector plug 111 when the connector plug 111 is mated to the connector socket 109.

The connector socket 109 includes a front panel ring 121, a body portion 122 and a dust cover 117. The body portion 122 includes external threads 122a configured to receive an optional socket fastener 123. The socket fastener 123 secures the connector socket 109 to a panel (not shown) as would be appreciated by one of ordinary skill in the art. In another embodiment, the connector socket 109 may be screwed or otherwise directly received into a panel or other similar console, or the connector socket 109 may use tabs, screws or other fasteners as would be appreciated by one of ordinary skill in the art to mount the connector socket 109 to the panel. In yet another embodiment, the connector socket may not include external threads 122a and socket fastener 123, but may be fastened to a panel or other surface by tabs, clips or other similar fastener devices.

Connector socket 109 is formed of a transparent, semi-transparent, translucent, semi-translucent material or other suitable material that illuminates when provided with light from light source 103. In one embodiment, the connector socket 109 is formed of polyethersulphone, which is a moldable plastic having heat resistant and chemical resistant properties. In another embodiment, the connector socket 109 is formed of a polycarbonate.

The connector socket 109 further includes a light pipe attachment feature (feature) 107. The feature 107 has a generally tubular geometry as shown in FIGS. 1 and 2. The feature 107 is disposed on a rear surface 118 of dust cover 117. In other words, the feature 107 has a closed end formed by rear surface 118. The feature 107 is integral to the dust cover 117. The feature 107 may be integrated with the dust cover 117 by bonding the feature 107 to dust cover 117 such as by ultrasonic welding, or by molding or casting the dust cover 117 to include the feature 107. In another embodiment not shown, the feature 107 is a recess or hole (not shown) formed into the rear surface 118 of dust cover 117. The recess or hole and may be formed by machining, molding, casting or other similar forming method.

The feature 107 is configured to releasably receive a light transmission pipe (light pipe) 105 by a friction fit. In another embodiment, the light pipe 105 is secured to the feature 107 by gluing, thermal welding, or other similar joining method. The feature 107 may be of any geometry configured to receive corresponding light pipe 105. In this exemplary embodiment, the feature 107 has a generally tubular geometry having an approximately 2 mm inside diameter d. The inside diameter d corresponds with the outside diameter d and geometry of the light pipe 105. As can be seen in FIG. 1, the feature 107 is receivably oriented at an angle parallel to a central axis 113 of the electrical connector assembly 101. To accommodate specific space limitations or other needs, the feature 107 can be oriented in any direction necessary.

The light pipe 105 may be a fiber optic cable, fiber optic fiber, or other similar light transmission structure as would be appreciated by one of ordinary skill in the art. The light source 103 may be a light emitting diode (LED), an incandescent light, a fluorescent light, or any other source of light. The light source 103 may provide more than one light color. Different colors may be used to indicate the status of the connector socket 109 or the status of the electrical connector assembly 101 when mated. The different colors may be used to distinguish a connector socket 109 or electrical connector assembly 101 from another connector socket 109 or another electrical connector assembly 101. Furthermore, different colors may be used to aid individuals attempting to insert or detach a connector plug 111 to a specific connector socket 109 when the connector socket is in an area that is difficult to reach, difficult to see, without adequate space, or with low ambient lighting.

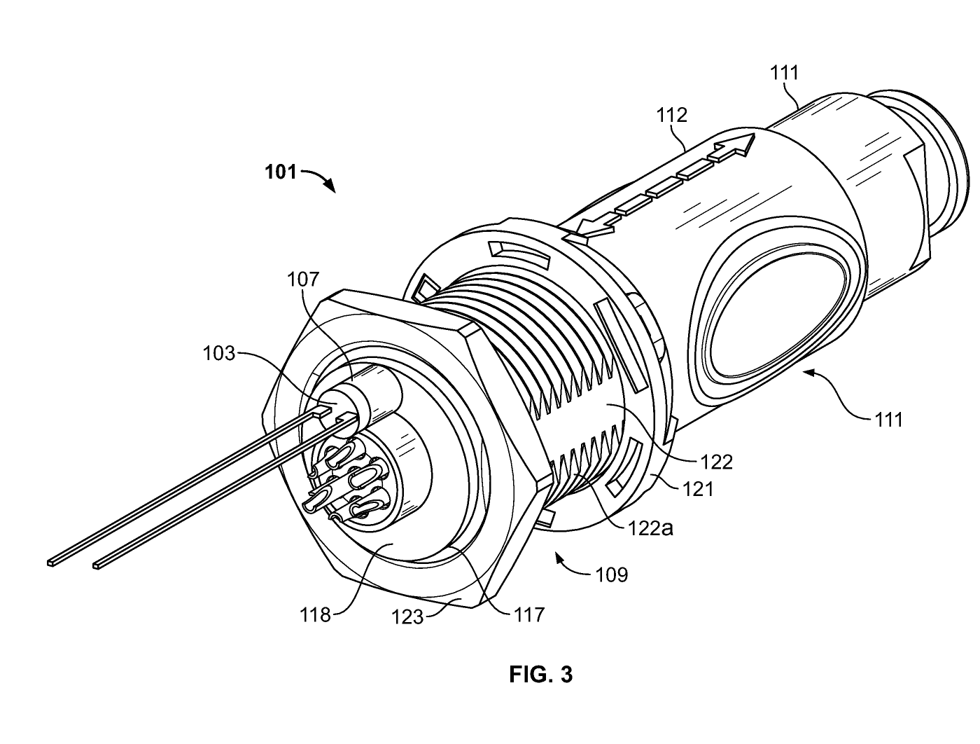

FIG. 3 shows another exemplary embodiment of an electrical connector assembly 101. As can be seen in FIG. 3, the light source 103 is at least partially disposed within the feature 107, thus eliminating the need for light pipe 105.

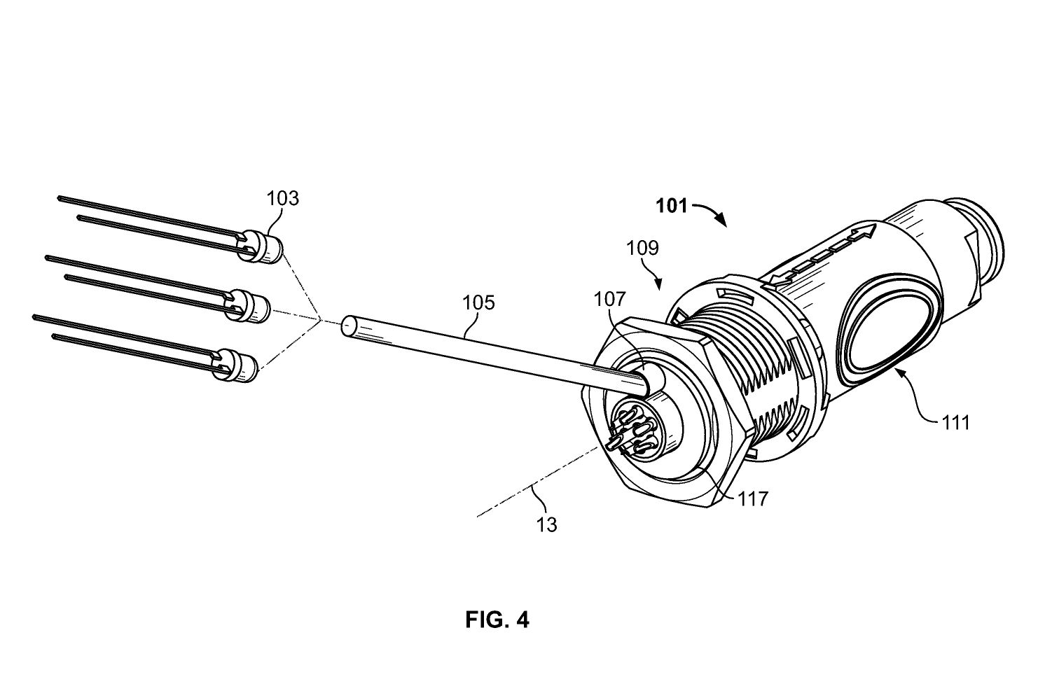

FIG. 4 shows yet another exemplary embodiment of electrical connector assembly 101. As shown in FIG. 4, the feature 107 is receivably oriented at an angle other than parallel to the central axis 13. In this exemplary embodiment, the feature 107 is receivably oriented at an angle of about 45° to the central axis 13 as shown. In alternative embodiments, the feature 107 may be receivably oriented at any angle from the central axis 13.

As further shown in FIG. 4, multiple light sources 103 provide light to light pipe 105. Each light source 103 may provide light of different colors to light pipe 105. Light sources 103 may be connected to light pipe 105 via light pipe branches (not shown) connected to the light pipe 105, or the light sources 103 may otherwise be configured to provide light to light pipe 105 as would be appreciated by one of ordinary skill in the art.

In yet another embodiment not shown, multiple light sources 103 may provide light to the connector socket 109 by providing more than one feature 107 on the connector socket 111 and connecting the more than one feature 107 to one or more light sources 103.

In one embodiment, the connector socket 109 is disposed in a control box (not shown) as would be appreciated by one of ordinary skill in the art. In this embodiment, the feature 107 may be internal to the control box. Due to the proximity of the connector socket 109 to other electrical connections and electrical devices associated with internal portions of the control box, it is preferred that the feature 107 be relatively small so as to not cause adverse effects on the other connections and devices by overcrowding the interior of the control box. However, the feature 107 must be large enough to allow a sufficient amount of light to enter the connector socket 109, while securely holding the light pipe 105.

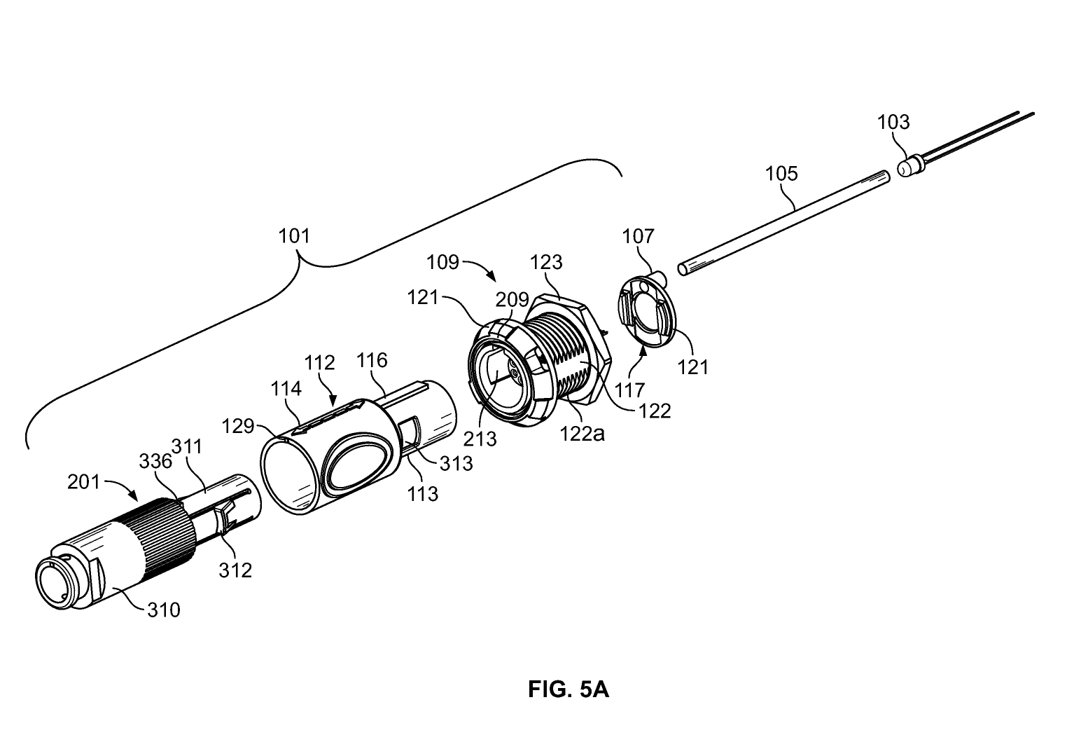

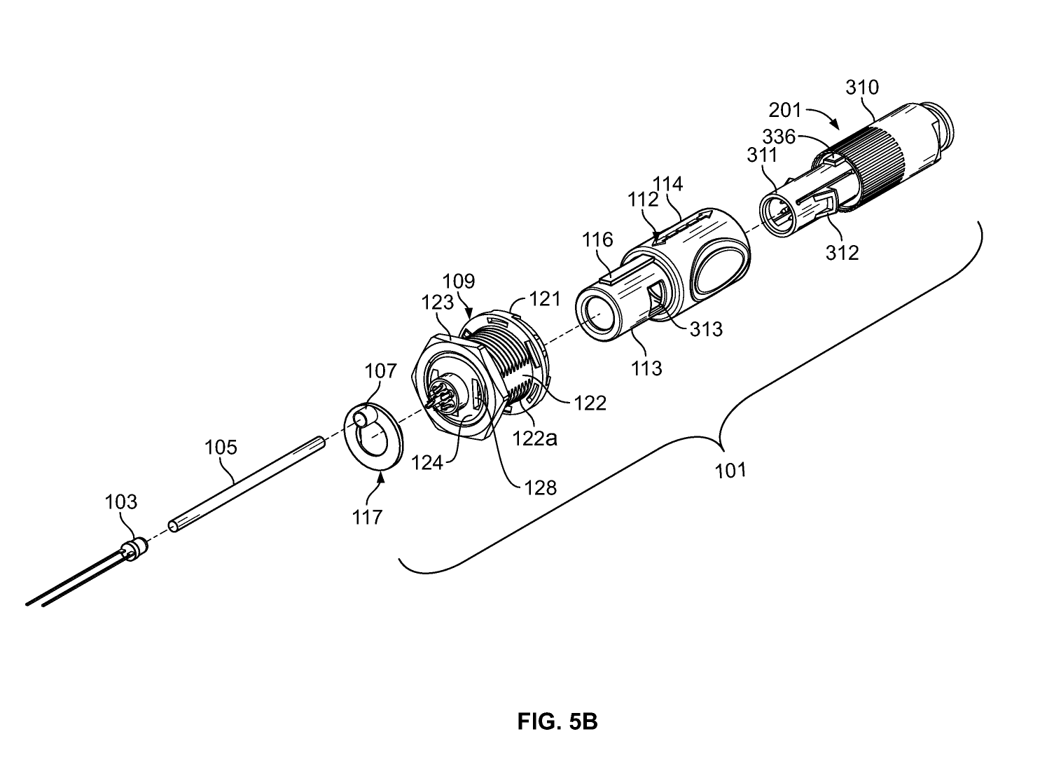

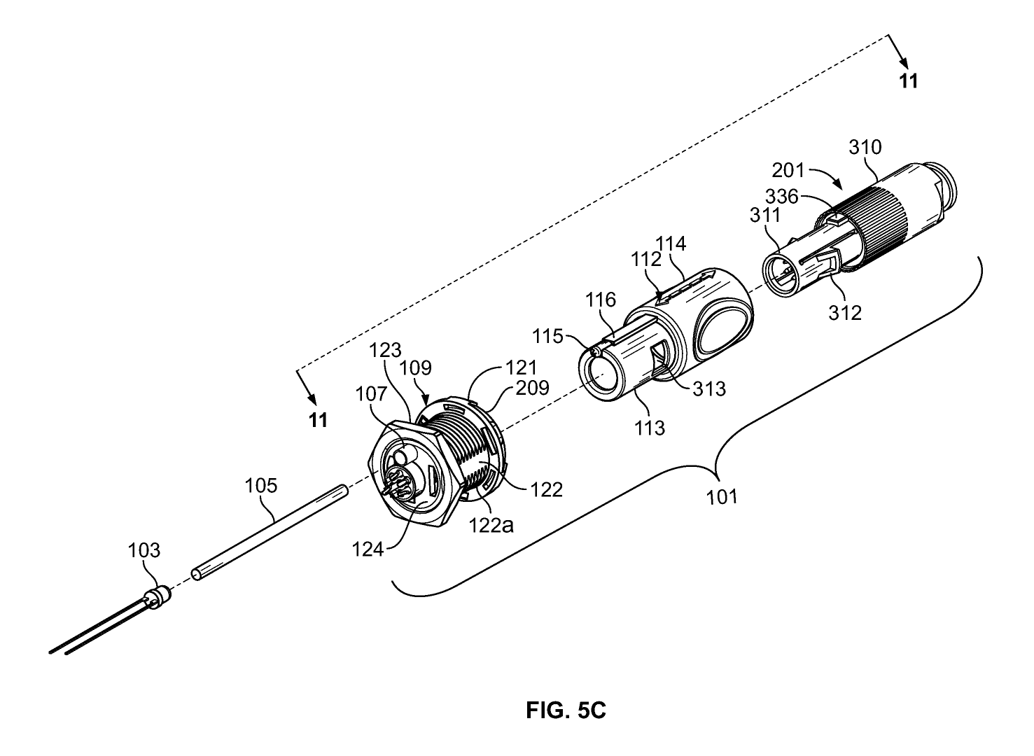

Referring again to FIGS. 1 and 2, the connector plug 111 includes an illumination sleeve 112 and a plug housing 201. The illumination sleeve 112 includes a sleeve insertion portion 113 and a sleeve body 114. The sleeve insertion portion 113 includes a key 116. The key 116 is configured to be received into a slot 209 (FIG. 5) in the connector socket 109 so as to align the connector socket 109 and the connector plug 111 when the connector socket 109 and connector plug 111 are connected.

In this exemplary embodiment, the illumination sleeve 112 is formed entirely of a translucent material, which illuminates when provided with light from the connector socket 109. For example, the illumination sleeve 112 may be entirely formed of any transparent, translucent, semi-transparent, semi-translucent, light-reactive, or reflective material. In one embodiment, the illumination sleeve 112 is formed of a polyethersulphone or a polycarbonate. In another embodiment, the sleeve insertion portion 113 is opaque and the key 116 and sleeve body 114 are translucent. In yet another embodiment, the sleeve body 114 is translucent and the key 116 and sleeve insertion portion 113 are opaque.

In another embodiment, the light pipe 105 is received in feature 107 to illuminate the connector socket 109, as described above. However, in this exemplary embodiment, the connector plug 111 is formed of an opaque material, so that only the connector socket 109 is illuminated when the connector socket 109 and connector plug 111 are coupled. In this embodiment, the illumination of the connector socket 109 is used to locate the connector socket 109 in low light conditions and/or to assist in coupling the connector plug 111 thereto.

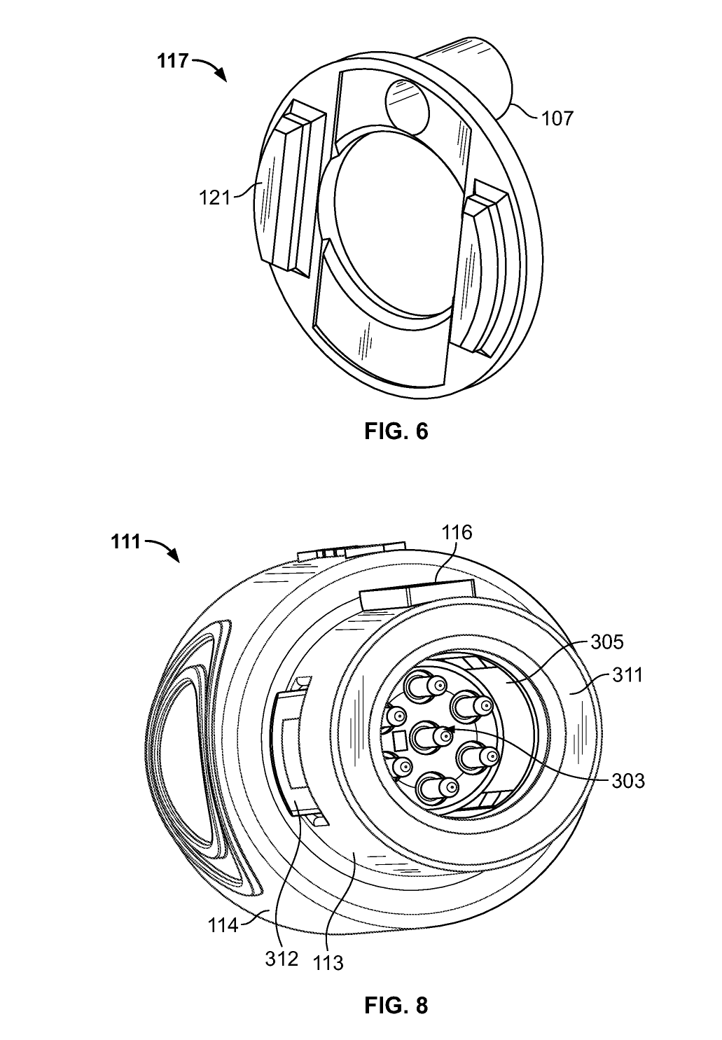

FIGS. 5A and 5B show an exploded perspective view of the electrical connector assembly 101 including connector socket 109 and connector plug 111. As can be seen in FIG. 6, dust cover 117 includes a fastener 121 configured to be received in slots 128 in a rear surface 124 of the body section 122 of connector socket 109 to attach dust cover 117 to the body section 122. The dust cover 117 approximately corresponds to the size and geometry of the rear surface 124 as shown. In another embodiment, the dust cover 117 may vary in size and shape from the rear surface 124.

The fastener 121 may be a snap, tab, screw, or other similar fastening mechanism. The dust cover 117 is aligned to the connector socket 109 by the fastener 121, however, in an alternative embodiment, additional alignment devices such as a groove, a slot, a key, or other alignment member may be used to align the dust cover 117 with the body portion 122. The dust cover 117 may be permanently affixed to the connector socket 109 by an adhesive, by friction, or by ultrasonic welding or other similar permanent affixing method.

As can be further seen in FIGS. 5A and 5B, the plug housing 201 includes plug housing body 310 and plug housing insertion portion 311. The plug housing 310 and the plug housing insertion portion 311 are configured to be received in sleeve body 114 and sleeve insertion portion 113, respectively.

Plug housing insertion portion 311 includes tabs 312 configured to be received in openings 313 in the sleeve insertion portion 113. The tabs 312 are further configured to be received in slots 213 in the connector socket 109 to releasably connect the connector plug 111 with the connector socket 109 as would be appreciated by one of ordinary skill in the art. As will be appreciated by one of ordinary skill in the art, the geometry and arrangement of the tabs 312 may vary in alternative embodiments to correspond to the geometry and arrangement of the corresponding elements.

Plug insertion portion 311 further includes a plug housing key 336 configured to be received in sleeve slot 129 in sleeve body 114. In other embodiments, the plug housing 201 may include other tabs, keys, slots, recesses or similar features to align the plug housing 201 and the illumination sleeve 112.

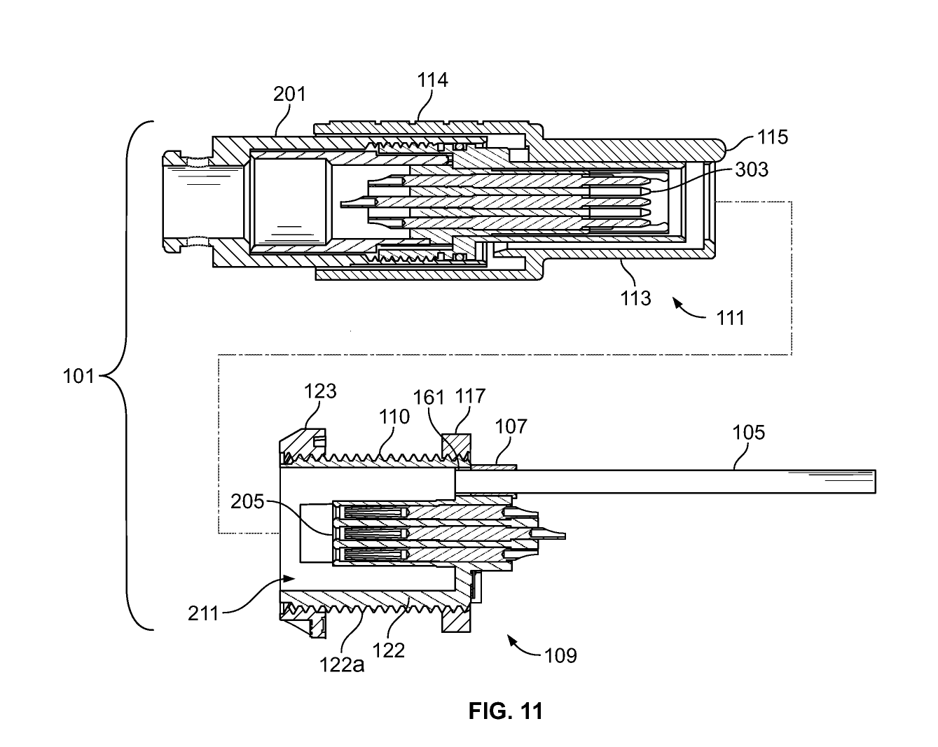

In yet another exemplary embodiment of the connector assembly 101 not shown, the embodiment shown in FIG. 5B is modified by adding a through hole 161 (FIG. 11) to the rear surface 124 of the socket body 122 as in FIG. 11, and the feature 107 is modified by adding a hole (not shown) through the dust cover 117 under the feature 107 to permit the light pipe 105 to extend through the dust cover 117 and be received in the through hole 161. In this exemplary embodiment, the illumination sleeve 112 includes a rounded feature 115 as shown in the embodiment shown in FIG. 5C. In such a manner, the rounded feature 115 will abut the light pipe 105 when the connector plug 111 and the connector socket 109 are mated, as discussed and shown in the embodiment shown in FIG. 5C below.

FIG. 5C shows another embodiment of the connector assembly 101 wherein the feature 107 is directly attached to the rear surface 124 of the socket body 122. In this embodiment, the feature 107 is attached over a through hole 161 (FIG. 11) through the rear surface 124 of the socket body 122. The feature 107 is integral to the socket body 122. The feature 107 may be integrated with the socket body 122 by bonding the feature 107 by ultrasonic welding or other similar joining method, or the socket body may be molded or cast to include the feature 107.

As further shown in FIG. 5C, the illumination sleeve 112 further includes a rounded feature 115 disposed on the sleeve insertion portion 113. The rounded feature 115 corresponds and approximately abuts the through hole 161 (FIG. 11) in the rear surface 124 of the socket body 122. In such a manner, the rounded feature 115 receives light from light pipe 105 to illuminate illumination sleeve 112. The rounded feature 115 has a partially rounded exterior shape as shown in FIG. 5C, however, in alternative embodiments, the rounded feature 115 may have other geometric shapes configured to correspond to feature 107. In another embodiment of the electrical connector assembly 101 not shown, the connector socket 109 is modified by omitting the feature 107 and the light pipe is received directly in the through hole 161.

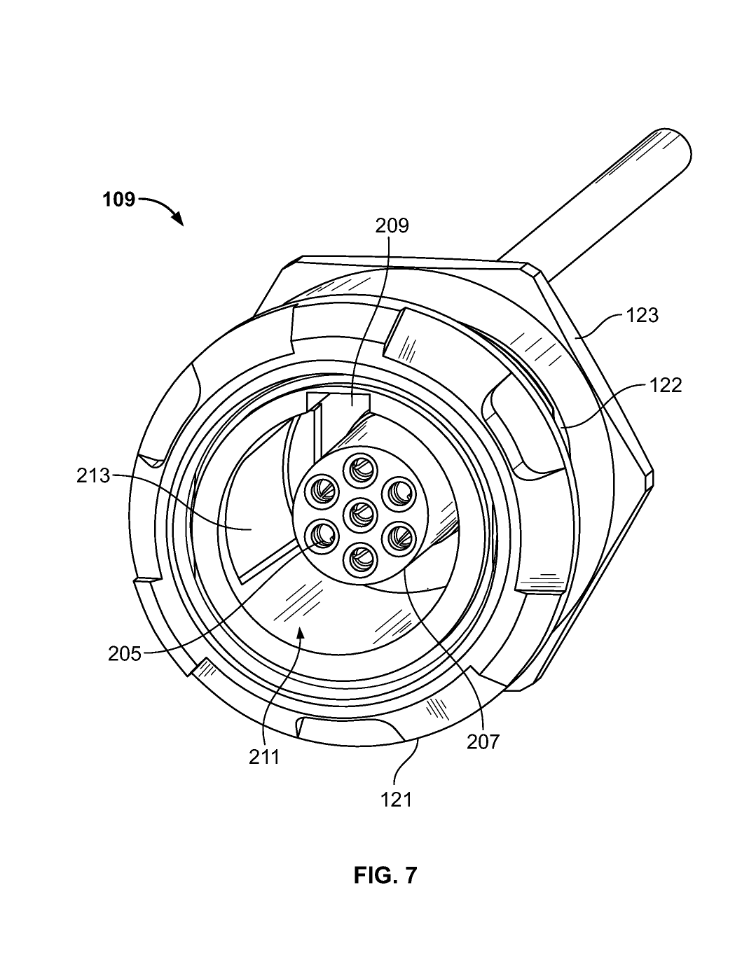

FIGS. 7 and 8 show a front view of the connector socket 109 and connector plug 111 of FIG. 2, respectively. As shown in FIG. 7, the connector socket 109, shown with light pipe 105 attached, includes socket body 122 at least partially defining an inner cavity 211 disposed therewithin. The inner cavity 211 is configured to receive the sleeve insertion portion 113 of connector plug 111. A socket contact interface 207 is disposed within the inner cavity 211. Socket contact interface 207 includes socket contacts 205.

As shown in FIG. 8, the connector plug 111 includes housing insertion portion 311 disposed within sleeve insertion portion 113. A plug cavity 305 is defined by and disposed within housing insertion portion 311. Pin contacts 303 are disposed within the plug cavity 305. The pin contacts 303 correspond and are configured to mate with socket contacts 205 (FIG. 7). In another embodiment, the connector plug 111 may include socket contacts 205 and associated structure and the connector socket 109 may include corresponding pin contacts and associated structure as appreciated by one of ordinary skill in the art. In yet another embodiment, connector plug 111 and connector socket 109 may contain any mateable contact pairs and contact support structure as would appreciated by one of ordinary skill in the art.

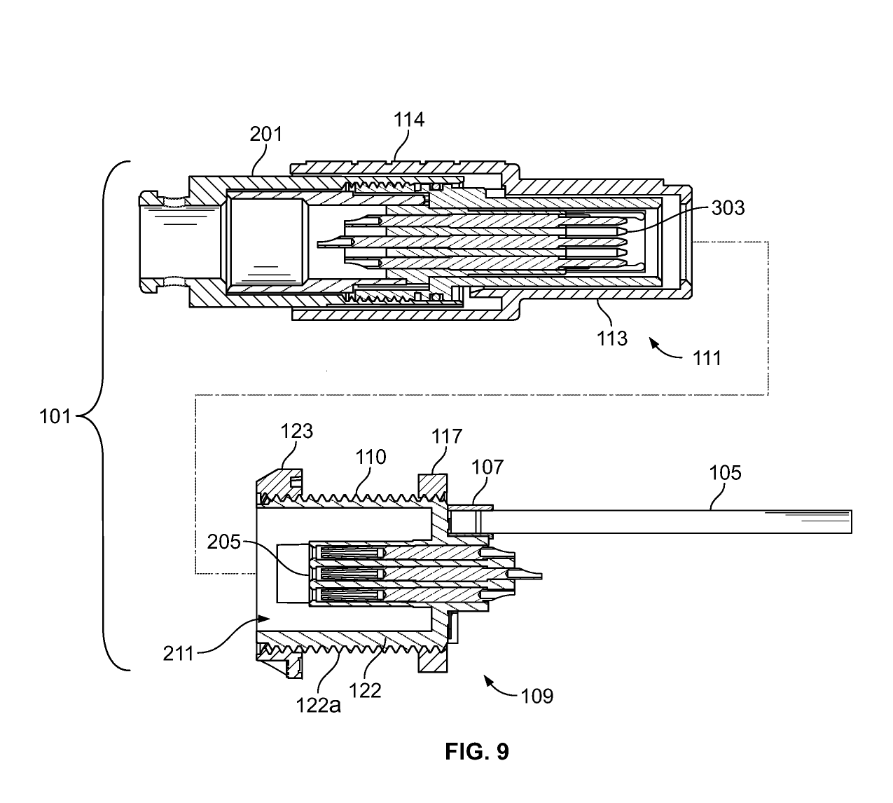

FIG. 9 shows a cross sectional view of the unmated electrical connector assembly 101 taken along line 8-8 of FIG. 2. FIG. 9 shows the details of the disposition of the socket contacts 205 and pin contacts 303 disposed within the connector socket 109 and the connector plug 111, respectively.

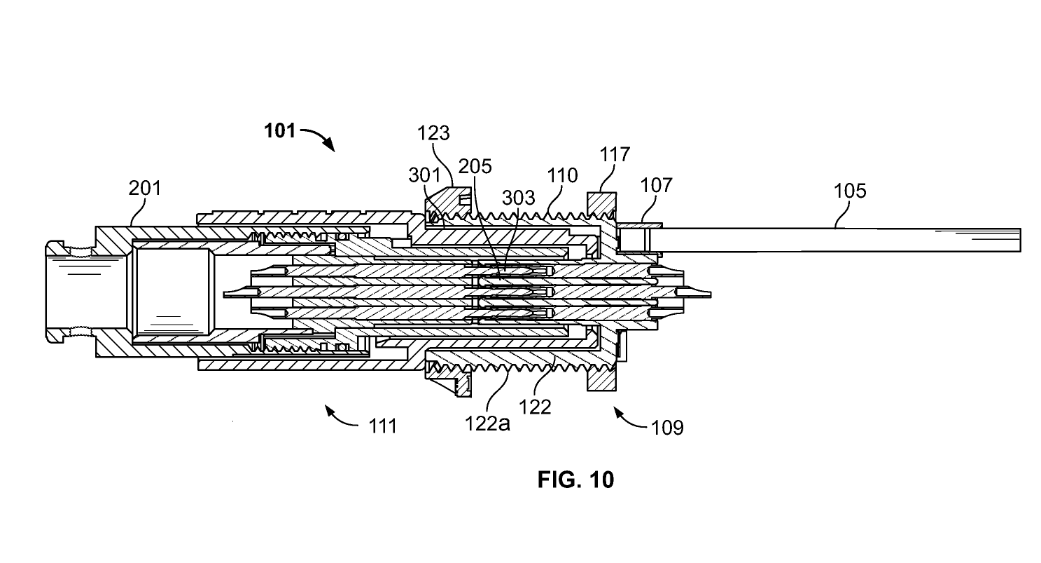

FIG. 10 shows a cross sectional view of the mated electrical connector assembly 101 of FIG. 1 taken along line 9-9 of FIG. 1. As can be seen in FIG. 10, by mating the connector plug 111 with the connector socket 109, the socket contacts 205 and the pin contacts 303 correspondingly mated.

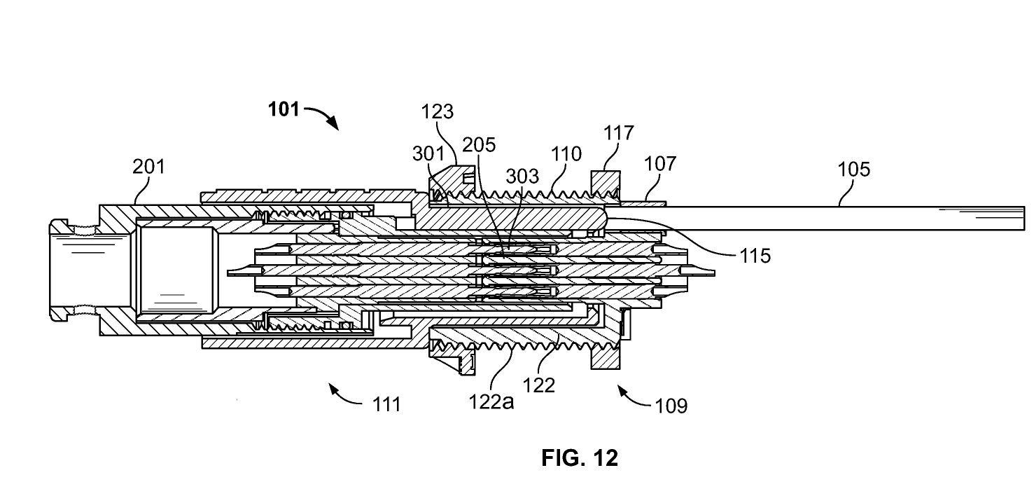

FIG. 11 shows a cross sectional view of the unmated electrical connector assembly 101 shown in FIG. 5C with the light pipe 105 inserted into the hole 161, and FIG. 12 shows the corresponding mated view of the electrical connector assembly 101 of FIG. 11. As can be seen in FIG. 12, the rounded feature 115 abuts the light pipe 105, which extends through hole 161.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed:

1. An electrical connector assembly comprising:
a connector plug comprising electrical contacts; and
a connector socket comprising corresponding electrical contacts and a light pipe attachment feature, the connector socket configured to mate with the connector plug and form an electrical connection between the electrical contacts and the corresponding electrical contacts,
wherein the light pipe attachment feature is configured to receive light from a light source to illuminate the connector socket.

2. The assembly of claim 1, wherein the light pipe attachment feature is further configured to provide light to the connector plug to illuminate the connector plug when the connector plug and the connector socket are mated.

3. The assembly of claim 1, wherein the light pipe attachment feature has a generally tubular geometry.

4. The assembly of claim 1, wherein the light pipe attachment feature is integrated into the connector socket.

5. The assembly of claim 1, wherein the connector socket further comprises a dust cover.

6. The assembly of claim 5, wherein the light pipe attachment feature is integrated into the dust cover.

7. The assembly of claim 1, wherein the light pipe attachment feature is configured to receive a fiber optic cable.

8. The assembly of claim 1, wherein the light pipe attachment feature is configured to receive light from a light source from a direction parallel to a central axis of the electrical connector assembly.

9. The assembly of claim 1, wherein the light pipe attachment feature is configured to receive light form a light source from a direction at an angle other than parallel to a central axis of the electrical connector assembly.

10. The assembly of claim 1, wherein the connector socket is formed of a material selected from the group consisting of transparent, semi-transparent, translucent, and semi-translucent materials.

11. The assembly of claim 1, wherein the connector plug is formed of a material selected from the group consisting of transparent, semi-transparent, translucent, and semi-translucent materials.

12. The assembly of claim 1, wherein the connector plug comprises a sleeve formed of a transparent material configured to permit light received from the connector socket to illuminate the connector plug.

13. The assembly of claim 12, wherein the sleeve comprises a rounded feature configured to receive light from the light pipe attachment feature.

14. The assembly of claim 1, wherein the light pipe attachment feature is configured to receive a light pipe inserted through the connector socket so as to abut or proximately abut a rounded feature on the connector plug when the connector plug and the connector socket are mated.

15. The assembly of claim 1, wherein the light pipe attachment feature is configured to receive an LED.

16. An electrical connector socket, comprising:
a front panel ring;
a body portion, and
a light pipe attachment feature configured to receive a light transmission pipe.

17. The socket of claim 16, wherein the electrical connector socket is formed of a material selected from the group consisting of transparent, semi-transparent, translucent, and semi-translucent materials.

18. The socket of claim 16, wherein the electrical connector socket is formed of a polysulphone or a polycarbonate material.

19. The socket of claim 16, wherein the light pipe attachment feature is a through hole in a rear surface of the body portion.

20. The socket of claim 16, wherein the electrical connector socket further comprises a dust cover having the light pipe attachment feature disposed thereupon, the dust cover configured to attach to the body portion.

21. The socket of claim 16, wherein the light pipe attachment feature has a generally tubular geometry.

22. A method of illuminating an electrical connector assembly, comprising:
providing a light source;
connecting a connector socket to the light source through a light pipe configured to illuminate the connector socket with light from the light source.

23. The method of claim 22, further comprising:
providing a connector plug configured to mate with the connector socket;
illuminating the connector plug with light from the light source when the connector socket and connector plug are mated.
